(19) United States
(12) Patent Application Publication
(10) Pub. No.: US 2010/0322834 A1
(43) Pub. Date: Dec. 23, 2010

(54) Method of and Apparatus for Treating Gas Containing Nitrous Oxide

(76) Inventors: Takehiko Ito, Ehime (JP); Fumio Kondo, Ehime (JP)

Correspondence Address: HAHN & VOIGHT PLLC, 1012 14TH STREET, NW, SUITE 620, WASHINGTON, DC, 20005, US

(21) Appl. No.: 12/225,410

(22) PCT Filed: Apr. 13, 2006
(86) PCT No.: PCT/JP2006/307845

§ 371 Date: Jul. 8, 2010

(51) Int. Cl. B01D 53/56; B01J 19/00

(52) U.S. Cl. 423/239.1; 422/198

(57) ABSTRACT

An apparatus for treating gas containing nitrous oxide, according to the present invention, includes dampers (113-116, 118-120, and 123-125) for introducing gas to be treated and for exhausting treated gas; a plurality of heat accumulating layers (102) charged with ceramic heat storage media; a plurality of catalyst layers (103) arranged in accordance with the respective heat accumulating layers, heat-decomposing nitrous oxide contained in the introduced gas to be treated into nitrogen; and a heating device (107) for increasing a temperature of the introduced gas to be treated to a heat-decomposable temperature in the catalyst layers.

### TECHNICAL FIELD

This invention relates to a method of and an apparatus for treating gas containing nitrous oxide, and in particular, to a method of and an apparatus for treating gas containing nitrous oxide, exhausted from nitric acid producing plants, caprolactam manufacturing plants, and adipic acid manufacturing plants.

### BACKGROUND ART

Nitrous oxide is contained in exhaust gas, for example, discharged from a nitric acid producing plant, generated in the process of making adipic acid from cyclohexanol or cyclohexane, produced in the process of oxidizing ammonia through a gas phase in manufacturing caprolactam, or caused after the use of an anesthetic.

Nitrous oxide is recognized as a gas vitiating the atmosphere of the earth. This is because it is assumed that, in the stratosphere, nitrous oxide is reacted to nitric oxide, which brings about the destruction of the ozonosphere. Nitrous oxide is also known as a greenhouse effect gas and its greenhouse effect is thought of as 310 times that of carbonic acid gas. From such reasons, nitrous oxide is designated as a target for the reduction of gas emission by the Kyoto Protocol.

On the other hand, it is known that nitric oxide is a stable substance and is decomposed only at temperatures of 800° C. or more in the absence of a catalyst. When the temperature further rises, the reaction of the decomposition into nitrogen and oxygen does not proceed, and at temperatures of 1000° C. or more, the proportion of the decomposition into nitric oxide is increased.

From the above description, it is now common practice to use the catalyst in order to decompose nitric oxide. For example, Patent Reference 1 described below sets forth a specific example where nitrous oxide secondarily produced in the manufacturing process of adipic acid is decomposed by using the catalyst that holds copper (II) oxide to alumina.

FIG. 1 shows this specific example. In FIG. 1, an oxidation exhaust gas 1 from the manufacturing process of adipic acid is fed to an NOₓ absorption tower 13. Nitrogen dioxide in the gas is absorbed by absorption water 2 and is drained as a nitric acid solution 3 from the bottom of the tower. From the top of the tower, an oxidation exhaust gas 4 containing N₂O as a main component is supplied to a feed gas preheating heat exchanger 14 in a state of nearly normal temperature and pressure. An oxidation exhaust gas 5 preheated here to a preset temperature is introduced into a catalyst-charged reactor 15. As the type of the catalyst-charged reactor 15, either a fixed bed or a fluidized bed may be used, and in the specific example, an isothermal reactor with the fixed bed is used. Most of decomposed heat is absorbed by hot water 10 and 11 circulated between the exterior of a reactor tube and a steam drum 17. The hot water is evaporated in the steam drum and its heat can be reused as steam 12. Evaporated moisture is always supplied as boiler feed water 9 from a reserve tank 18.

It is described that in starting operation in which the temperature of the reactor is low, the oxidation exhaust gas 4 is conducted to an introduction pipe 19 and must be heated to a preset temperature by a preheater 20 for starting operation. It is also described that, for this, means for burning hydrocarbon and other inflammable gases or liquids are considered, but any means that is capable of supplying a necessary heat quantity may be used, irrespective of its kind.

Patent Reference 1: Japanese Patent Kokai No. Hei 5-4027

The decomposition reaction of nitrous oxide is caused only at 300-400° C. or more even when the catalyst is used, depending on a state of coexistence with a reaction-inhibiting substance, and thus the temperature of the gas containing nitrous oxide, as in the conventional example mentioned above, must be elevated to the reaction starting temperature. Depending on the concentration of nitrous oxide, it becomes necessary to always operate the preheater 20 for starting operation in order to hold the heat balance of a reaction system. In such a case, fuel consumption becomes large and an increase of CO₂ exhaust gas is caused. Hence, it is necessary to provide a decomposition system in which the consumption of fuel required to maintain the temperature of the gas containing nitrous oxide is small and the generation of CO₂ is minimized.

The object of the present invention, therefore, is to provide a treating method and apparatus that requires a little energy for the decomposition of nitrous oxide.

### DISCLOSURE OF THE INVENTION

A method of treating gas containing nitrous oxide according to the present invention is characterized in that gas to be treated is heated to 300-600° C. by using ceramic heat storage media and a combustion-aid means, and nitrous oxide is heat-decomposed into nitrogen by catalysts.

A method of treating gas containing nitrous oxide according to the present invention is characterized in that the heat of treated gas after being heat-decomposed is accumulated in the ceramic heat storage media so that this accumulated heat is added to next-introduced gas to be treated.

An apparatus for treating gas containing nitrous oxide according to the present invention comprises dampers for introducing gas to be treated and for exhausting treated gas, a plurality of heat accumulating layers charged with ceramic heat storage media, a plurality of catalyst layers arranged in accordance with the respective heat accumulating layers to heat-decompose nitrous oxide contained in the introduced gas to be treated into nitrogen, and a heating means for increasing the temperature of the introduced gas to be treated to a heat-decomposable temperature in the catalyst layers.

### BRIEF DESCRIPTION OF THE DRAWINGS

FIG. 1 is a schematic view showing one conventional example of a treating apparatus for decomposing gas containing nitrous oxide by using catalysts.

FIG. 2 is a view showing a fundamental structure of a treating apparatus for decomposing gas containing nitrous oxide by using catalysts, according to the present invention.

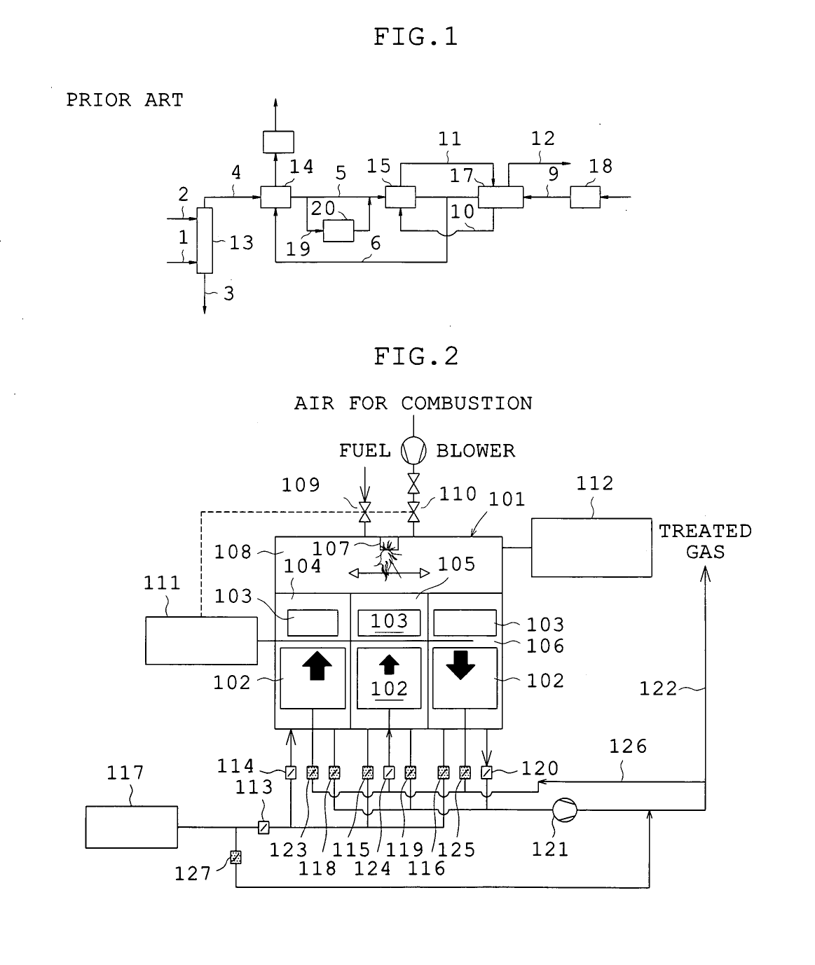

### BEST MODE FOR CARRYING OUT THE INVENTION

FIG. 2 shows one embodiment of a treating apparatus according to the present invention. In this figure, reference numeral 101 represents a reactor, the interior of which is constructed with: three sets of heat accumulation-catalyst sections 104, 105, and 106, each having a heat accumulating layer 102 including ceramic heat storage media and a catalyst layer 103 composed of catalysts holding precious metals, such as platinum, provided on the heat accumulating layer 102; and a heat up section 108 provided on these heat accumulation-catalyst sections, including a combustion-aid means 107 such as a burner. Reference numeral 109 represents an automatic valve for feeding fuel to the combustion-aid means 107. Reference numeral 110 represents an automatic valve for feeding air for combustion to the combustion-aid means 107. Reference numeral 111 represents a temperature controller for detecting a temperature between the accumulating layer 102 and the catalyst layer 103 in each of the heat accumulation-catalyst sections 104, 105, and 106 to control the automatic valves 109 and 110. And, Reference numeral 112 represents a temperature alarm sounding an alarm when the temperature in the heat up section 108 exceeds a preset value.

The bottoms of the heat accumulation-catalyst sections 104, 105, and 106 are coupled with: gas distribution piping connected to a source of gas to be treated, that is, a nitrous-oxide-containing gas source 117 through switching dampers 113, 114, 115, and 116; gas exhaust piping connected to a treated gas discharge pipe 122 through switching dampers 118, 119, 120, and 116 and a blower 121; and gas exhaust piping connected to a purge pipe 126 connected to the treated gas discharge pipe 122 through switching dampers 123, 124, and 125. In addition, through a switching damper 127, the upstream side of the switching damper 113 of the gas distribution piping is connected to the downstream side of the blower 121 of the treated gas discharge pipe 122.

In the operation of the reactor mentioned above, the switching dampers 113, 114, 120, and 124 are opened, the switching dampers 115, 116, 118, 119, 125, and 127 are closed, the combustion-aid means 107 is ignited, and the blower 121 is driven. In this way, gas to be treated is sucked from the source 117 of gas to be treated into the heat accumulation-catalyst section 104 by the suction force through the gas distribution piping, and the treated gas is exhausted into the treated gas discharge pipe 122 through the heat accumulating layer 102, the catalyst layer 103, the heat up section 108, the catalyst layer 103 of the heat accumulation-catalyst section 106, and the heat accumulating layer 102 of the heat accumulation-catalyst section 106. Part of the treated gas is introduced as purge gas into the heat accumulation-catalyst section 105 through the purge pipe 126. The purge gas enters the heat up section 108 through the heat accumulating layer 102 and the catalyst layer 103 of the heat accumulation-catalyst section 105. The gas also enters the heat accumulation-catalyst section 106 along the flow of the gas of the section 108 and is exhausted into the treated gas discharge pipe 122 through the catalyst layer 103 and the heat accumulating layer 102 of the heat accumulation-catalyst section 106.

In the above treatment, the temperature of the gas to be treated, that is, the gas containing nitrous oxide, introduced into the heat accumulation-catalyst section 104 is elevated to a proper catalyst-reaction treating temperature (between about 400 and 600° C.) while the gas passes through the heat accumulating layer 102 in which heat is accumulated. The gas is then decomposed into nitrogen and oxygen by the catalyst layer 103 and is introduced into the heat up section 108 so that it is preheated. After that, in another heat accumulation-catalyst section 106, a residual nitrous oxide component is decomposed into nitrogen and oxygen by the catalyst layer 103, heats the heat accumulating layer 102, and after losing heat, is exhausted outside the system by the blower 121. During this process, in the heat up section 108, fuel, such as kerosene, LPG, or light oil, is burned by the heating means 107 in accordance with a gas temperature at the lower portion of the catalyst layer 103 in the heat accumulation-catalyst section 106 so that the temperature of the catalyst layer 103 is always maintained to a preset value. In other words, the heating means 107 is controlled by the temperature controller 111 so that the entrance temperature of the catalyst layer 103 is always appropriate.

In this way, when a preset time passes, combinations of opening and closing of the switching dampers 114-116, 118-120, and 123-125 are switched in turn and the flow of the gas to be treated is changed so that a heat accumulating layer in which heat is accumulated becomes an entrance layer, and a heat accumulating layer in which heat should be accumulated becomes an exit layer. By repeating this switching, it becomes possible to increase thermal efficiency to 95% or more and running cost can be reduced.

The purge pipe 126 is a line for preventing untreated gas from leaking on a treating side when the flow of gas to be treated is switched. Although a heat accumulation-catalyst section connected to this line is used as a purge section for expelling the untreated gas, an actual amount of this leak is small and thus the purge pipe need not necessarily be provided in view of economy.

Also, in this case, when the switching damper is switched, a fluctuation in pressure occurs in the apparatus even though the fluctuation is slight. In an apparatus in which such fluctuation in pressure cannot be tolerated, it is desirable to use a rotary type that is capable of continuously switching an exhaust gas line, instead of the switching damper.

In the above embodiment, reference has been made to the case where two or three sets of heat accumulation-catalyst sections are connected. However, the present invention is not limited to this aspect and may be constructed so that four or more sets of the sections are connected, without departing from the scope and spirit of the present invention.

Subsequently, what follows is the result of comparison between the apparatus of the present invention and an apparatus of a common system of this type on the conditions described below.

Amount of exhaust gas to be treated: 20,000 m³N/hr

Exhaust gas temperature: 80° C.

Catalyst treating temperature: 450° C.

Fuel: Natural gas 10,000 kcal/m³

Amount of production of CO₂ and fuel consumption

| | | Common system | Present |
|---|---|---|---|
| | | Use of heat | invention |
| | Common system | exchanger | Heat |
| | No heat | (Heat exchanger | accumulation |
| | exchanger | efficiency 60%) | system |
| Amount of produc- | 530 kg/hr | 216 kg/hr | 28 kg/hr |
| tion of CO₂ | | | |
| Natural gas | 270 m³/hr | 110 m³/hr | 14 m³/hr |
| consumption | | | |

According to the present invention, the catalyst temperature is changed and thereby it is possible to prevent the deterioration of catalyst activity due to the time-dependent change and to adjust N₂O abatement efficiency.

The present invention has higher thermal efficiency than in the conventional system, and thus even though the treating temperature of the catalyst is changed, fluctuations of fuel cost and of the amount of production of CO₂ are small and performance can be adjusted at will.

The result of comparison relative to the amount of production of CO₂ and the fuel consumption where the treating temperature of the catalyst is set to 500° C. is as shown in the following table.

| | | Common system | Present |
|---|---|---|---|
| | | Use of heat | invention |
| | Common system | exchanger | Heat |
| | No heat | (Heat exchanger | accumulation |
| | exchanger | efficiency 60%) | system |
| Amount of produc- | 609 kg/hr | 246 kg/hr | 30 kg/hr |
| tion of CO₂ | | | |
| Natural gas | 310 m³/hr | 125 m³/hr | 15 m³/hr |
| consumption | | | |

Also, the reaction of the present invention is an exothermic reaction, and when the temperature of gas to be treated is increased to more than 600° C. and the reaction is caused, the destruction of the catalyst originates, which is unfavorable. Moreover, when the temperature of the gas to be treated is set to less than 300° C., the decomposition reaction is not produced.

Since the optimum temperature of the gas to be treated depends on the actual amounts of nitrous oxide and moisture contained in the gas to be treated, it is desirable to previously find the optimum temperature.

### INDUSTRIAL APPLICABILITY

An apparatus according to the present invention is extremely useful as a treating apparatus in which operating cost can be materially reduced and a gas containing nitrous oxide that is the greenhouse effect gas is reduced.

1. A method of treating gas containing nitrous oxide, characterized in that gas to be treated is heated to 300-600° C. by using ceramic heat storage media and a combustion-aid means, and nitrous oxide is heat-decomposed into nitrogen by catalysts.

2. A method of treating gas containing nitrous oxide, characterized in that the heat of treated gas after being heat-decomposed is accumulated in the ceramic heat storage media so that this accumulated heat is added to next-introduced gas to be treated.

3. An apparatus for treating gas containing nitrous oxide, comprising
dampers for introducing gas to be treated and for exhausting treated gas,
a plurality of heat accumulating layers charged with ceramic heat storage media,
a plurality of catalyst layers arranged in accordance with the respective heat accumulating layers to heat-decompose nitrous oxide contained in the introduced gas to be treated into nitrogen, and
a heating means for increasing the temperature of the introduced gas to be treated to a heat-decomposable temperature in the catalyst layers.
